(19) United States
(12) Patent Application Publication
(10) Pub. No.: US 2025/0048058 A1
(43) Pub. Date: Feb. 6, 2025

(54) DIGITAL TETHER VIA SATELLITE

(71) Applicant: Apple Inc., Cupertino, CA (US)

(72) Inventors: Krishna Myneni, San Jose, CA (US); Dhruv Khati, San Jose, CA (US); Anjaneyulu Maganti, San Jose, CA (US); Sanjeevi Balasubramanian, San Jose, CA (US)

(21) Appl. No.: 18/364,378

(22) Filed: Aug. 2, 2023

(51) Int. Cl. H04W 4/029; H04W 16/26

(52) U.S. Cl. CPC H04W 4/029; H04W 16/26

(57) ABSTRACT

The present disclosure relates to techniques that may be utilized to transmit radio frequency (RF) signals to an electronic device. A distance that a first electronic device of a plurality of electronic devices is located from a second electronic device of the plurality of electronic devices may be determined. Additionally, that the distance exceeds a first threshold distance may be determined. Whether the first electronic device is communicatively coupled to a cellular network, whether the distance exceeds a second threshold distance that is greater than the first threshold distance, or both are also determined. The RF signals radio frequency (RF) signals to be transmitted to the first electronic device by a satellite based on the first electronic device not being communicatively coupled to the cellular network, the distance exceeding the second threshold, or both.

### BACKGROUND

The present disclosure relates generally to wireless communication, and more specifically to wireless communication techniques that may be utilized to enable users to locate one another, for example, in situations where users have or may become separated from one another.

In an electronic device, a transmitter and a receiver may each be coupled to one or more antennas to enable the electronic device to both transmit and receive wireless signals, for example, from a base station (e.g., a cell tower) within a cellular network. In some instances, electronic devices may be or become located in geographic locations at which the electronic devices may not receive cellular service or connect to a cellular network. For example, in the context of users hiking in a relatively remote location, electronic devices of the users may not be able to connect to a cellular network, for example, to communicate with other devices via the cellular network or have Internet access. In cases in which one or more users may become separated from one another (e.g., due to differences in pace, terrain, or visibility), a user may become separated and not be able to communicate with other users using his or her electronic device.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a non-transitory computer-readable medium includes instructions that, when executed by processing circuitry, cause the processing circuitry to determine a distance that a first electronic device of a plurality of electronic devices is located from a second electronic device of the plurality of electronic devices and to determine that the distance exceeds a first threshold distance. When executed, the instructions also cause the processing circuitry to determine whether the first electronic device is communicatively coupled to a cellular network, whether the distance exceeds a second threshold distance that is greater than the first threshold distance, or both. Moreover, when executed, the instructions cause the processing circuitry to cause one or more radio frequency (RF) signals to be transmitted to the first electronic device by a satellite based on the first electronic device not being communicatively coupled to the cellular network, the distance exceeding the second threshold, or both.

In another embodiment, an electronic device includes a transceiver and processing circuitry operatively coupled to the transceiver. The processing circuitry is configured to determine a distance that a first electronic device of a plurality of electronic devices is located from a second electronic device of the plurality of electronic devices. The processing circuitry is also configured to determine that the distance exceeds a first threshold distance. Additionally, the processing circuitry is configured to determine whether the first electronic device is communicatively coupled to a cellular network and whether the distance exceeds a second threshold distance that is greater than the first threshold distance. Furthermore, the processing circuitry is configured to cause one or more radio frequency (RF) signals indicative of waypoint data to be transmitted to the first electronic device by a satellite based on the first electronic device not being communicatively coupled to the cellular network and the distance exceeding the second threshold. The waypoint data is indicative of navigational directions for a user of the first electronic device.

In yet another embodiment, a computer-implemented method includes determining, via processing circuitry, a distance that a first electronic device of a plurality of electronic devices is located from a second electronic device of the plurality of electronic devices. The computer-implemented method also includes determining, via the processing circuitry, that the distance exceeds a first threshold distance. Additionally, the computer-implemented method includes determining, via the processing circuitry, whether the first electronic device is communicatively coupled to a cellular network and whether the distance exceeds a second threshold distance that is greater than the first threshold distance. Furthermore, the computer-implemented method includes causing, via the processing circuitry, one or more radio frequency (RF) signals indicative of waypoint data to be transmitted to the first electronic device by a satellite based on the first electronic device not being communicatively coupled to the cellular network and the distance exceeding the second threshold. The waypoint data is indicative of navigational directions for a user of the first electronic device.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a functional diagram of the electronic device of FIG. 1, according to embodiments of the present disclosure;

FIG. 3 is a schematic diagram of a communication system including the electronic device of FIG. 1 communicatively coupled to a wireless communication network supported by base stations, according to embodiments of the present disclosure;

FIG. 4 is a block diagram of system that includes electronic devices, one or more base stations and/or satellites, and one or more servers, according to embodiments of the present disclosure;

FIG. 5 is a flow diagram of a process for providing waypoint data to an electronic device, such as the electronic device of FIG. 1 or one of the electronic devices of FIG. 4, according to embodiments of the present disclosure;

FIG. 6 is a user interface of the application of FIG. 4, according to embodiments of the present disclosure;

FIG. 7 illustrates an example scenario in which several users are participating in a hike, according to embodiments of the present disclosure;

FIG. 8 is a flow diagram of a process for determining a mode of wireless communication for transmitting waypoint data, according to embodiments of the present disclosure; and

FIG. 9 is a flow diagram of a process for designating a new group leader in the application of FIG. 4, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately.” “near.” “about.” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed wireless communication techniques that may be utilized to communicate data (e.g., via wireless signals) to electronic devices of users. For instance, in some instances, electronic devices may be or become located in geographic locations at which the electronic devices may not receive cellular service or connect to a cellular network. For example, in the context of users hiking in a relatively remote location, electronic devices of the users may not be able to connect to a cellular network, for example, to communicate with other devices via the cellular network or have Internet access. In cases in which one or more users may become separated from one another (e.g., due to differences in pace, terrain, or visibility), a user may become separated from other users. In some of these cases, the user may not be able to communicate with other users using his or her electronic device, for instance, due to the device not being connected to a cellular network and the electronic device of the user being too far from electronic devices of the other users to be able to communicate with the electronic devices of the other users.

Embodiments herein provide various apparatuses and techniques to enable the transmission of waypoint data to electronic devices. The waypoint data, for example, may be displayed on a display of an electronic device of a user who is, may be, or may become separated from users of other electronic devices. For example, as discussed below a group of users may be defined using an application. When a user in the group is determined to have become separated (e.g., based on the user's electronic device being a distance away from another electronic device of another user of the group that exceeds a threshold distance), a mode of wireless communication to be used to communicative with the separated user may be determined. Based on several other factors or determinations described below, the waypoint data may ultimately be transmitted to the electronic device of the separated user using one of several wireless communication techniques, including, but not limited to, cellular network communication (e.g., via one or more base stations), ultra-wideband communication (e.g., via an electronic device of another user in the group), device-to-device communication (via one or more electronic devices of one or more users of the group), or satellite communication (e.g., via a satellite). Accordingly, waypoint data may be provided to the electronic device of the separated user, thereby enabling the separated user to regroup with users of the group.

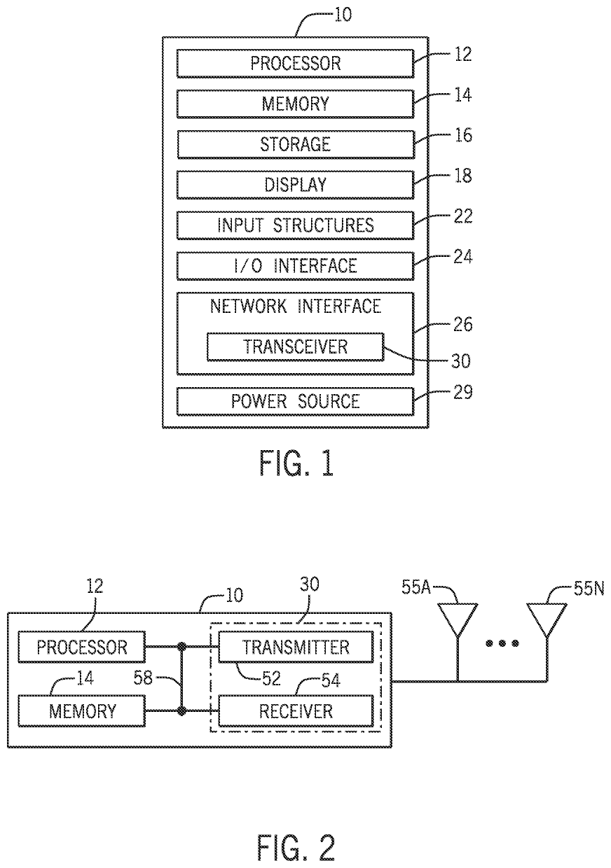

FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, and other similar devices. In additional or alternative embodiments, the electronic device 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, Long Term Evolution® (LTE) cellular network, Long Term Evolution License Assisted Access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. The power source 29 of the electronic device 10 may include any suitable source of power, such as a rechargeable lithium polymer (Li-poly) battery and/or an alternating current (AC) power converter.

FIG. 2 is a functional diagram of the electronic device 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) may be communicatively coupled directly or indirectly (e.g., through or via another component, a communication bus, a network) to one another to transmit and/or receive signals between one another.

The electronic device 10 may include the transmitter 52 and/or the receiver 54 that respectively enable transmission and reception of signals between the electronic device 10 and an external device via, for example, a network (e.g., including base stations or access points) or a direct connection. As illustrated, the transmitter 52 and the receiver 54 may be combined into the transceiver 30. The electronic device 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The electronic device 10 may include multiple transmitters, multiple receivers, multiple transceivers, and/or multiple antennas as suitable for various communication standards. In some embodiments, the transmitter 52 and the receiver 54 may transmit and receive information via other wired or wireline systems or means.

As illustrated, the various components of the electronic device 10 may be coupled together by a bus system 56. The bus system 56 may include a data bus, for example, as well as a power bus, a control signal bus, and a status signal bus, in addition to the data bus. The components of the electronic device 10 may be coupled together or accept or provide inputs to each other using some other mechanism.

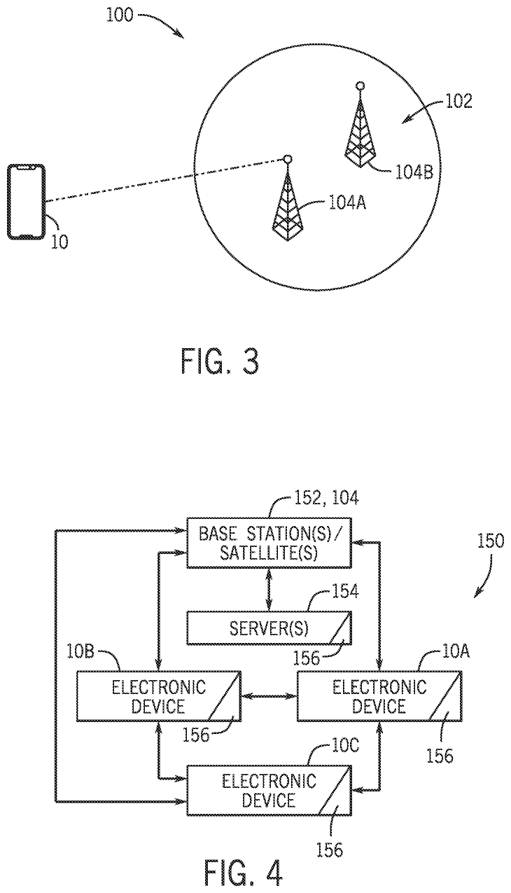

FIG. 3 is a schematic diagram of a communication system 100 including the electronic device 10 of FIG. 1 communicatively coupled to a wireless communication network 102 supported by base stations 104A, 104B (collectively 104), according to embodiments of the present disclosure. In particular, the base stations 104 may include Next Generation NodeB (gNodeB or gNB) base stations and may provide 5G/NR coverage via the wireless communication network 102 to the electronic device 10. The base stations 104 may include any suitable electronic device, such as a communication hub or node, that facilitates, supports, and/or implements the network 102. In some embodiments, the base stations 104 may include Evolved NodeB (eNodeB) base stations and may provide 4G/LTE coverage via the wireless communication network 102 to the electronic device 10. Each of the base stations 104 may include at least some of the components of the electronic device 10 shown in FIGS. 1 and 2, including one or more processors 12, the memory 14, the storage 16, the transceiver 30, the transmitter 52, and the receiver 54. It should be understood that while the present disclosure may use 5G/NR as an example specification or standard, the embodiments disclosed herein may apply to other suitable specifications or standards (e.g., such as the 4G/LTE specification, a sub-4G specification, a beyond 5G specification, such as a 6G specification, and so on). Moreover, the network 102 may include any suitable number of base stations 104 (e.g., one or more base stations 104, four or more base stations 104, ten or more base stations 104, and so on).

As noted above, the presently disclosed techniques may enable communication to and/or between electronic devices of different users, for instance, when at least one user is separated or may be separated from one or more other users. For example, when hiking a user may become separated from other users, and the techniques described herein may be utilized to aid the separated user and/or other users in regrouping or finding one another.

Bearing this in mind, FIG. 4 is a block diagram of a system 150 that includes electronic devices 10 (referring collectively referring to electronic device 10A, electronic device 10B, and electronic device 10C), one or more base stations and/or satellites 152, and one or more servers 154. As discussed below, the electronic devices 10 and the one or more server 154 may execute an application 156 to enable users of the electronic devices 10 to monitor one another's locations as well as aid in rejoining one or more of the users with one or more other users, for instance, when a user becomes separated from other users. However, before describing the application 156 in more detail, the electronic devices 10, the one or more base stations and/or satellites 152, and the one or more server(s) will be discussed.

The electronic devices 10 may be any suitable electronic device and may include any of the components of the electronic device 10 discussed above with respect to FIG. 1 and FIG. 2. Additionally, while three electronic devices 10 are illustrated in the system 150, in other embodiments, fewer (e.g., two) or more (e.g., four or more) electronic devices 10 may be included in the system 150. The electronic devices 10 may communicate with one another using any suitable type of wireless communication, including but not limited to the types of wireless communication described above. The electronic devices 10 may also be communicatively coupled to the one or more base stations and/or satellites 152, for example, in a cellular network, satellite network, non-terrestrial network, or any combination thereof. As the one or more base stations and/or satellites 152 are communicatively coupled to the one or more servers 154, the electronic devices 10 may be communicatively coupled to the one or more servers 154 via the one or more base stations and/or satellites 152 or a portion thereof or a combination of at least a portion of the one or more base stations and/or satellites 152, and one or more server(s) and one or more other electronic devices of the electronic devices 10. Furthermore, the application 156 may be included in the memory 14 or storage 16 of the electronic devices 10 and executed by the processors 12 of the electronic devices 10.

The one or more base stations and/or satellites 152 may include the one or more base stations 104, such as the base station 104A and/or the base station 104B discussed above with respect to FIG. 3. The one or more base stations and/or satellites 152 may also include one or more satellites that may be capable of transmitting and receiving wireless signals. Accordingly, the one or more base stations and/or satellites 152 may enable one or more wireless networks (e.g., one or more WANs, such as, but not limited to, a network defined by or related to any standards related to the Third Generation Partnership Project (3GPP), including, for example, a 3^{rd} generation (3G) cellular network, universal mobile telecommunication system (UMTS), 4^{th} generation (4G) cellular network. Long Term Evolution® (LTE) cellular network, Long Term Evolution License Assisted Access (LTE-LAA) cellular network, 5^{th} generation (5G) cellular network, and/or New Radio (NR) cellular network, a 6^{th} generation (6G) or greater than 6G cellular network, a satellite network, or a non-terrestrial network). In one embodiment, the one or more base stations and/or satellites 152 includes at least one base station 104 and at least one satellite. In other embodiments, the one or more base stations and/or satellites 152 may include more than one base station 104, more than one satellite, or more than one base station 104 and more than one satellite.

The one or more servers 154 may be or include any suitable computing device or devices. As such, the one or more servers 154 may include at least some of the components of the electronic device 10 shown in FIGS. 1 and 2, including one or more processors 12, the memory 14, the storage 16, the transceiver 30, the transmitter 52, and the receiver 54. Furthermore, the application 156 may be included in the memory 14 or storage 16 of the one or more servers 154 and executed by the processors 12 of the one or more servers 154. As discussed below, the application 156 may be utilized to locate the electronic devices 10 as well as to provide notifications and or instructions to the electronic devices 10. Provision of the notifications and/or instructions to a particular electronic device 10 may occur via another of the electronic devices 10, a base station 104 (e.g., of the one or more base stations and/or satellites 152), a satellite (e.g., of the one or more base stations and/or satellites 152) depending on one or more of several factors discussed below. For example, the application 156 may be a location tracking application that may be utilized to track the location (e.g., a geographic location or relative position) of the electronic devices 10. The one or more servers 154 (e.g., using the storage 16 or external storage that is communicatively coupled to the one or more servers 154) store or utilize data regarding the users (e.g., names, ages or birthdays, health information) and/or the electronic devices 10. Additionally, the one or more servers 154 may determine the locations of the electronic devices 10 (e.g., using a navigation system such as the Global Positioning System (GPS)), for example, by executing the application 156. As such, the application 156 may be utilized to determine the locations of the electronic devices 10 as well as distances between the electronic devices 10. The one or more servers 154 may also obtain or maintain weather data.

The application 156, when executed by the one or more servers 154 and/or one or more of the electronic devices 10 may also determine and provide waypoint data to one or more of the electronic devices 10, such as an electronic device 10 of a user that has become separated. The waypoint data may include, navigation data, such as written or visual directions that can be displayed via the display 18 of a user's electronic device 10 to provide the user with directions to move to one or more particular locations (e.g., to regroup with one or more other users of the electronic devices 10). For example, as discussed below, when a user becomes separated (e.g., based on the user's electronic device 10 being located a distance away from another user's electronic device 10 that exceeds a threshold distance), waypoint data may be determined and provided the other user's electronic device 10 (using a determined form of wireless communication). For instance, in the context of FIG. 4, the electronic device 10A may belong to a first user, the electronic device 10B may belong to a second user, and the electronic device 10C may belong to a third user. The users may be designated in the application 156 as being in a group, with the user of the electronic device 10A being the group leader. In such a context, when either the electronic device 10B or the electronic device 10C is located a distance from the electronic device 10A that exceeds a threshold distance (or one of several threshold distances), waypoint data may be determined and provided to the electronic device 10B and/or electronic device 10C to enable the user of the electronic device 10B and/or the user of electronic device 10C to navigate to no longer be separated from the group leader (e.g., when the electronic device 10B and/or electronic device 10C going from having a distance greater than the threshold distance to a distance that is equal to or less than the threshold distance).

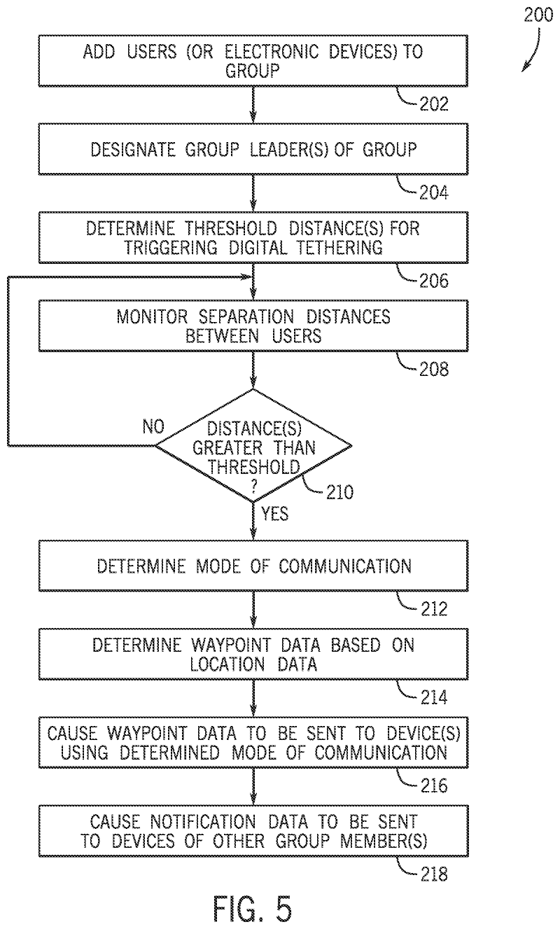

FIG. 5 is a flow diagram of a process 200 for providing waypoint data to an electronic device, such as one or more of the electronic devices 10, according to embodiments of the present disclosure. Any suitable device (e.g., a controller) that may control components of the electronic device 10, such as the processor 12, may perform the process 200. In some embodiments, the process 200 may be implemented by executing instructions stored in a tangible, non-transitory, computer-readable medium, such as the memory 14 or storage 16, using the processor 12 (of one or more of the electronic devices 10, the one or more servers 154, or both). For example, the process 200 may be performed at least in part by one or more software components, such as an operating system of the electronic device 10, one or more software applications of the electronic device 10 or the one or more servers 154, such as the application 156. While the process 200 is described using steps in a specific sequence, it should be understood that the present disclosure contemplates that the described steps may be performed in different sequences than the sequence illustrated, and certain described steps may be skipped or not performed altogether. The process 200 generally includes adding users or electronic devices of the users to a group (e.g., process block 202), designating one or more group leaders of the group (e.g., process block 204), determining one or more threshold distances for triggering digital tethering (e.g., process block 206), monitoring separation distances between users (e.g., process block 208), determining whether one or more of the separation distances exceeds a corresponding threshold distance (decision block 210), and, upon determining that none of the separation distances exceeds the corresponding threshold distance, continuing to monitor the separation distances between users (e.g., process block 208). However, upon determining that one or more of the separation distances exceeds the correspond threshold distance, the process 200 may include determining a mode of communication (e.g., process block 212), determining waypoint data based on location data (e.g., process block 214), causing the waypoint data to be sent to one or more electronic devices of users (e.g., having separation distances that exceed a corresponding threshold distance) using the mode of communication (e.g., process block 216), and causing notification data to be sent to electronic devices of other users, such as other group members (e.g., process block 218).

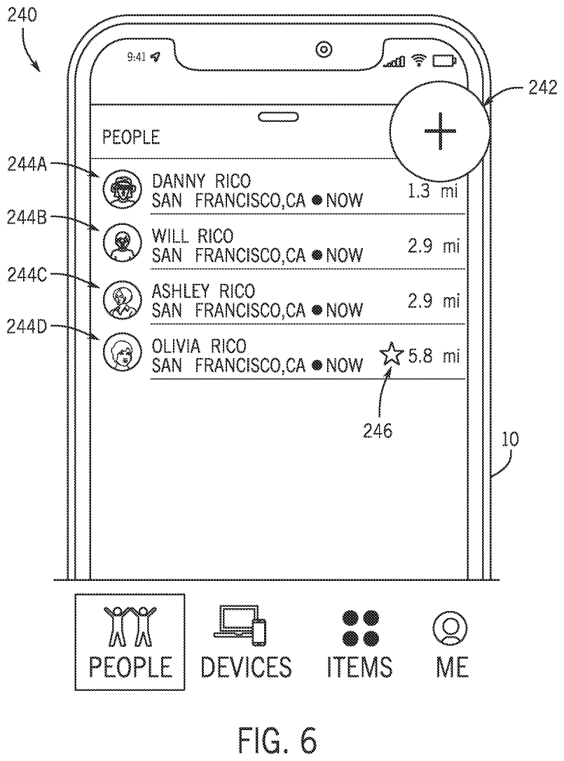

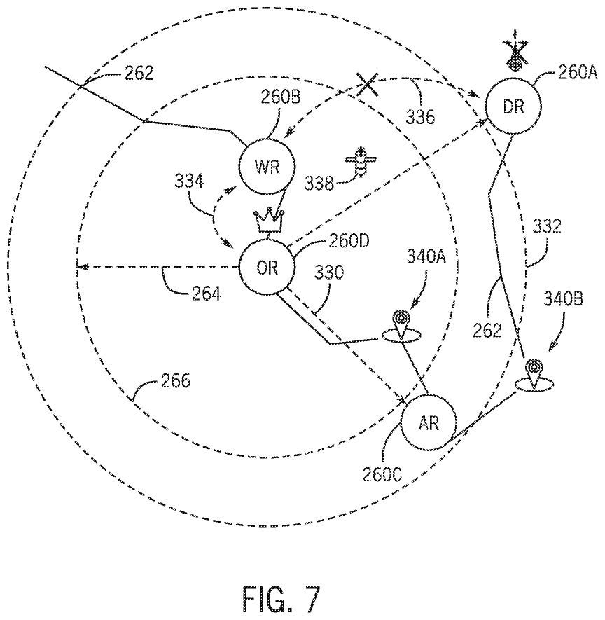

In process block 202, users (or electronic devices of the users) may be added to a group using the application 156. For example, FIG. 6 illustrates a user interface 240 of the application 156 that may be provided via the display 18 of an electronic device 10, such as any of the electronic devices 10 of FIG. 1, FIG. 4, or FIG. 7 (discussed below). The user interface 240 may include an interface item 242 to add users to the group as well as list users included in the group (e.g., users corresponding to interface items 244 (collectively referring to interface item 244A, interface item 244B, interface item 244C, interface item 244D)). The interface item 242 may be selectable, for instance, via a user input using the input structures 22 or, in embodiments in which the display 18 is or includes a touchscreen, the display 18 (e.g., a touch or tapping motion). Upon selection of the interface item 242, contacts (e.g., stored in the memory 14, storage 16, or elsewhere) of the user of the electronic device 10 may be presented on the display 18, and the user may select one or more of the display contacts to add the contact(s) to the group. The interface item 244A may be for a first user (e.g., a first group member), the interface item 244B may be for a second user (e.g., a second group member), the interface item 244C may be for a third user (e.g., a third group member), and the interface item 244D may be for a fourth user (e.g., a fourth group member).

The respective interface items 244 may include a graphical representation of a respective group member (e.g., a picture of the user or another image associated with a particular user), a location of the respective group member (e.g., a geographic location such as a city, state, and/or country of an electronic device 10 of the group member, such as “San Francisco, CA” as illustrated in FIG. 6), an indication of how recently the location was determined (e.g., “now”), a distance that the respective group member is from the user of the electronic device 10 (e.g., the distance between the electronic device 10 of the group member of the particular interface item 244 and the user of the electronic device 10), and an indication 246 of whether a particular group member is the group leader. While the indication 246 is illustrated as being a star in FIG. 6, in other embodiments, the indication 246 may differ. For instance, the indication 246 may be text-based or have a shape other than a star. While FIG. 6 includes a single instance of the indication 246 (meaning there is one group leader), in other embodiments, there may be more than one indication 246 (indicating that there are several group leaders). Because the indication 246 is included in the interface item 244D, the indication 246 is indicative of the fourth user being the group leader.

To help provide further detail about the process 200, an example context is provided in FIG. 7 and will be discussed with at least respect to FIG. 5. In particular, FIG. 7 illustrates an example scenario in which several users are participating in a hike. In FIG. 7, includes circles that are representative of users 260 (referring collectively to user 260A, user 260B, user 260C, and user 260D) and/or electronic devices 10 of the users 260. The users 260 correspond to the interface items 244 of FIG. 6. That is, the user 260A may be the group member represented by the interface item 244A, the user 260B may be the group member represented by the interface item 244B, the user 260C may be the group member represented by the interface item 244C, and the user 260D may be the group member represented by the interface item 244D. As such, the user 260D may be the group leader of the group represented in the user interface 240 of FIG. 6. In the context of FIG. 7, the users 260 may be a group of people who are hiking (e.g., along a hiking path 262).

Returning to FIG. 5 and the discussion of the process 200, in process block 204, one or more group leaders of the group may be designated via the application 156. For example, one or more of the users 260 may select one or more users as the group leader via a user input with a user interface of the application 156. In another embodiment, a user that originally invites other users (e.g., one or more of the users 260) may be designated (e.g., by default) as the group leader of the group. As discussed above with respect to FIG. 6 and FIG. 7, the user 260D corresponding to interface item 244D is indicated as being the group leader of the group by the indication 246.

In process block 206, the application 156 (e.g., as executed by one or more processors 12 of one or more of the electronic devices 10 or one or more processors 12 of the one of more servers 154) may determine one or more threshold distances for triggering digital tethering. “Digital tethering” refers to providing directions or instructions to a user, for instance, who has become separated from other members of the group. Indeed, as discussed above, a particular user may be determined to be separated upon the distance between the user and a group leader exceeding a threshold distance associated with the particular user. The threshold distance may be determined in several ways. For example, the threshold distance may be a default distance (e.g., a distance in feet or yards or meters such as 50 meters, 100 meters, 150 meters, 200 meters, or any other suitable distance). In another embodiment, the threshold distance may be selected for a user from several predetermined distances based on one or more of several factors (or calculated using a formula or algorithm that takes into account the one or more factors) such as weather, age, height, elevation, terrain, and topography. For example, when the weather is clear (e.g., sunny), larger threshold distances may be used compared to other weather conditions in which visibility may be lower (e.g., rain, snowy, sleet, hail, foggy, windy conditions, forest fires, smog or other pollution, etc.). As another example, when the outdoor temperature is relatively more temperate (e.g., compared to relatively hot or relatively cold temperatures), larger threshold distances may be utilized in comparison to when hot conditions (e.g., based on temperature and/or heat index) or cold conditions (e.g., near or below freezing temperatures) are present at a user's location. Additionally, shorter distances may be utilized for children and/or senior citizens (e.g., with shorter and shorter distances being used for younger and younger and/or older and older users) compared to users aged 18-65 (or any other suitable range of ages). Moreover, in wooded or forested areas, relatively shorter distances may be utilized as the threshold distance compared to open area (e.g., fields). Somewhat similarly, relatively shorter threshold distances may be used for areas with varying topographies and elevations (e.g., hilly or mountainous areas) relative to areas with less varying elevations or topographies (e.g., flat areas).

In some embodiments, the threshold distance may be selected by a group leader. For instance, a group leader may input or select a threshold distance for one or more users via a user input to the group leader's electronic device 10 into the application 156. Furthermore, in some embodiments, the threshold distance(s) may be dynamically determined, meaning a threshold distance may change. For instance, as nonlimiting examples, when a user moves from one type of terrain to another or weather conditions change, the threshold distance may be modified from a first threshold distance to a second threshold distance.

Turning briefly to FIG. 7, in the illustrated context, a threshold distance determined at process block 206 may be represented by line 264, with a circle 266 having the line 264 as a radius indicating an area (e.g., within the circle 266) that is within the threshold distance of the group leader (e.g., user 260D). Conversely, areas outside of the circle 266 have distances that exceed the threshold distance. While FIG. 7 illustrates a single threshold distance being utilized for multiple users, it should be reiterated (and, as discussed above), that multiple threshold distances may be used. For instance, in one embodiment, there may be up to as many threshold distances as there are members in the group (e.g., users other than the group leader when there is a single group leader).

Returning to FIG. 5 and the discussion of the process 200, in process block 208, the application 156 (e.g., as executed by one or more processors 12 of one or more of the electronic devices 10 or one or more processors 12 of the one of more servers 154) may monitor separation distances between the users 260 (or the electronic devices 10 of the users 260). More specifically, the distances of group members relative to the group leader may be monitored. For example, the location of the users 260 may be determined, and the distance between each of the users 260A, 260B, 260C relative to the user 260D may be determined.

In decision block 210, the application 156 (e.g., as executed by one or more processors 12 of one or more of the electronic devices 10 or one or more processors 12 of the one or more servers 154) may determine whether a distance determined at process block 208 exceeds a corresponding threshold distance (e.g., determined at process block 206). In other words, each respective distance determined at process block 208 may be compared to a respective threshold distance to determine whether the respective distance is greater than the respective threshold distance. As noted above, a user (e.g., one or more of the users 260) may be considered to be separated when the distance associated with the user (and/or the electronic device 10 of the user) exceeds the threshold distance associated with the user (and/or the user's electronic device 10). If in decision block 210 the application 156 determines that the separations distances of the users do not exceed their respective threshold distance(s), the process 200 may return to process block 208, and the separation distance distances between the users of the electronic devices 10 may continue to be monitored (e.g., by the application 156 as executed by one or more processors 12 of one or more of the electronic devices 10 or one or more processors 12 of the one or more servers 154). In other words, when the distance associated with each of the users 260 is determined to be within the respective threshold distance(s) associated with the user 260, the application 156 may continue to monitor the distances between group members and the group leader.

However, if in decision block 210 the application 156 determines that the distance determined at process block 208 exceeds its respective threshold distance, in process block 212, the application 156 (e.g., as executed by one or more processors 12 of one or more of the electronic devices 10 or one or more processors 12 of the one or more servers 154) may determine a mode of communication. In other words, when one or more of the users 260 (or the electronic devices 10 of the one or more users 260) are located farther away from the group leader than the threshold distance, a mode of communication may be determined. The mode of communication may be utilized to wirelessly transmit waypoint data to the electronic device(s) of the user(s) having distances from the group leader that exceed the threshold distance. Referring briefly to FIG. 7 in the context of discussing discussion block 210, the user 260B may be determined to be within the threshold distance of the user 260D, while user 260A and user 260C may be determined to be at distances from the user 260D that exceed the threshold distance (e.g., because the user 260A and the user 260C are located outside of the circle 266). As such, one or more modes of communication to communicate with the electronic devices 10 of the user 260A and the user 260C may be determined (e.g., at process block 212).

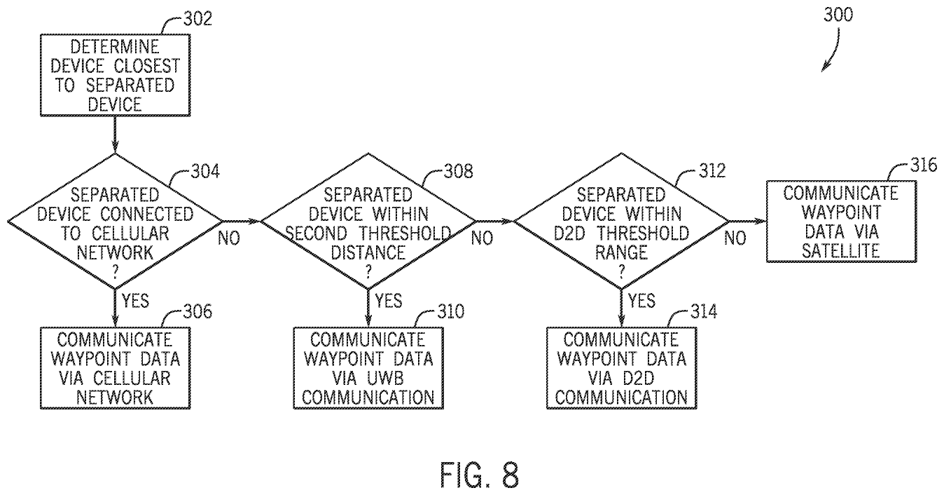

To help provide more detail as to how the mode of communication may be determined at process block 212. FIG. 8 is provided. In particular, FIG. 8 is a flow diagram of a process 300 for determining a mode of communication (e.g., to be used to transmit waypoint data to an electronic device 10), according to embodiments of the present disclosure. Any suitable device (e.g., a controller) that may control components of the electronic device 10, such as the processor 12, may perform the process 300. In some embodiments, the process 300 may be implemented by executing instructions stored in a tangible, non-transitory, computer-readable medium, such as the memory 14 or storage 16, using the processor 12 (of one or more of the electronic devices 10, the one or more servers 154, or both). For example, the process 300 may be performed at least in part by one or more software components, such as an operating system of the electronic device 10, one or more software applications of the electronic device 10 or the one or more servers 154, such as the application 156. While the process 300 is described using steps in a specific sequence, it should be understood that the present disclosure contemplates that the described steps may be performed in different sequences than the sequence illustrated, and certain described steps may be skipped or not performed altogether. The process 300 generally includes determining an electronic device closest to a separated device, such an electronic device 10 determined at decision block 210 of the process 200 to be have a separation distance that exceeds a threshold distance for the electronic device 10 (e.g., process block 302), determining whether the separated device is connected to a cellular network (e.g., decision block 304), and upon determining that the separated device is communicated to a cellular network, determining to communicate waypoint data to the separated device via the cellular network (e.g., process block 306). However, upon determining the separated device is not connected to a cellular network, the process 300 may include determining whether the separated device is within a second threshold distance (of the electronic device determined to be the closest to the separated device) (e.g., decision block 308) and, upon determining the separated device is within the second threshold distance, determining to communicate waypoint data to the separated device via another type of wireless network, such as an UWB network (e.g., process block 310). However, upon determining that the separated device is not within the second threshold distance, the process 300 may include determining whether the separated device is within a device-to-device (D2D) threshold range of one or more electronic devices of the group members (e.g., decision block 312) and, upon determining that the separated device is within the D2D threshold range, determining to communicate waypoint data to the separated device using D2D communication (process block 314). However, upon determining that the separated device is not within the D2D threshold range, the process 300 may include determining to communicate waypoint data to the separated device via a satellite (e.g., process block 316).

In process block 302, the application 156 (e.g., as executed by one or more processors 12 of one or more of the electronic devices 10 or one or more processors 12 of the one or more servers 154) may determine an electronic device closest to a separated device, such an electronic device 10 determined at decision block 210 of the process 200 to be have a separation distance that exceeds a threshold distance for the electronic device 10. Such a determination may be made based on the locations of the electronic device 10 or the separation distances between the electronic devices 10, for instance, as determined at process block 208 of the process 200. Referring to FIG. 7 and the context illustrated therein in which the user 260C and the user 260A are located at distances greater than the threshold distance away from the user 260D (e.g., the group leader), the electronic device 10 of the user 260C may be determined to be closest to the user 260D. The electronic device 10 of the user 260A may be determined to be closest to the electronic device of the user 260D or the electronic device of the user 260B. However, for the purposes of illustrating features of the present disclosure, the present example context of FIG. 7 will be discussed as though the electronic device 10 of the group leader (e.g., user 260D) were determined to be nearest to the electronic device 10 of the user 260A.

Returning to FIG. 8 and the discussion of the process 300, in decision block 304, the application 156 (e.g., as executed by one or more processors 12 of one or more of the electronic devices 10 or one or more processors 12 of the one or more servers 154) may determine whether the separated device is connected to a cellular network. The cellular network may be a cellular network provided by or established at least partially using terrestrial base stations. For example, the cellular network may be the wireless communication network 102 of FIG. 4 that is established using the base station 104. As another example, the cellular network may be a wireless network supported by at least one base station 104 of the one or more base stations and/or satellites 152 of FIG. 4. Referring briefly to FIG. 7 and continuing with the discussion of the example context, a determination may be made as to whether the electronic device 10 of the user 260C is communicatively coupled to a cellular network (or a base station 104 of the cellular network), and a determination may be made as to whether the electronic device 10 of the user 260 is communicatively coupled to a cellular network (or a base station 104 of the cellular network).

Returning to FIG. 8 and the discussion of the process 300, upon determining that the separated device is communicated to a cellular network, at process block 306, the application 156 (e.g., as executed by one or more processors 12 of one or more of the electronic devices 10 or one or more processors 12 of the one or more servers 154) may determine to communicate waypoint data to the separated device via the cellular network. For example, in the context of FIG. 4, waypoint data (once determined) may be communicated from one of the electronic devices 10 (of another group member) and/or the one or more servers 154 via the one or more base stations and/or satellites 152.

In the example being discussed with respect to FIG. 7 though, both electronic devices 10 of the user 260A and the user 260C may be determined to not be connect to a cellular network. Referring back to FIG. 8, upon determining a separated device is not connected to a cellular network, at decision block 308, and the application 156 (e.g., as executed by one or more processors 12 of one or more of the electronic devices 10 or one or more processors 12 of the one or more servers 154) may determine whether the separated device is within a second threshold distance of another electronic device 10, such as the electronic device 10 determined to be the closest (at process block 302) or the electronic device 10 of the group leader. The second threshold distance may be a distance associated with a type of wireless communication other than cellular network communication. That is, the second threshold distance may be a distance associated with another type of wireless network than a cellular network. For example, the second threshold distance may be a maximum distance that two devices can have and still be (directly) communicatively coupled to another via an UWB network. That is, the second threshold distance may be associated with a maximum distance that UWB signals may be transmitted from an electronic device (e.g., the electronic device 10 determined to be the closest (at process block 302) or the electronic device 10 of the group leader) to the separated electronic device. In some embodiments, the second threshold distance may be a preset or predetermined distance, such as, but not limited to, 200 meters. Referring to FIG. 7 and continuing with the discussion of the example context thereof, the second threshold distance may be represented by line 330, which is the radius of a circle 332, meaning any users 260 or electronic devices 10 inside of the circle 332 are within the second threshold distance of the user 260D, and any users 260 outside the circle 332 are not within the second threshold distance of the user 260D.

Depending on the first threshold distance, the second threshold distance may be greater than or less than the first threshold distance. Referring to FIG. 8, in embodiments in which the second threshold distance is less than the first threshold distance, decision block 308 may optionally be skipped, and the process may process from decision block 304 (e.g., the “no” branch) to decision block 312.

Upon determining the separated device is within the second threshold distance, at process block 310, the application 156 (e.g., as executed by one or more processors 12 of one or more of the electronic devices 10 or one or more processors 12 of the one or more servers 154) may determine to communicate waypoint data to the separated device via another type of wireless network or type of wireless communication, such as an UWB network or using UWB signals (e.g., process block 310). For example, in the context of FIG. 7, the application 156 may determine that the electronic device 10 of the user 260D (e.g., the group leader) is to transmit waypoint data (e.g., once determined) to the electronic device 10 of the user 260C (based on the electronic device 10 of the user 260C being within the second threshold distance, as indicated by the user 260 being located inside of the circle 332).

Referring to FIG. 8, upon determining that the separated device is not within the second threshold distance, at decision block 312, the application 156 (e.g., as executed by one or more processors 12 of one or more of the electronic devices 10 or one or more processors 12 of the one or more servers 154) may determine whether the separated device is within a device-to-device (D2D) threshold range of one or more electronic devices of the group members. The D2D threshold range may be a distance associated with D2D communication, which is direct communication between two mobile devices (e.g., two of the electronic devices 10 of the users 260) without traversing the one or more base stations and/or satellites 152. For instance, D2D communication may generally be non-transparent to the cellular network (e.g., wireless communication network 102) and can occur on the cellular frequencies (i.e., inband) or unlicensed spectrum (i.e., outband). D2D communication may also utilize a number of “hops,” which generally refers to the number of devices from which data is transmitted (e.g., from an original transmitting device) before reaching a final receiving device. For example, data may be sent from a first electronic device 10 to another electronic device 10, which may then transmit the data (e.g., waypoint data) to the separated device utilizing D2D communication. Thus, at decision block 312, the application 156 may determine whether the separated device is within the D2D threshold range by determining whether the separated device is within a threshold distance of electronic device 10 and whether the electronic device 10 is within a maximum number of hops of another electronic device 10, such as the electronic device 10 of the group leader. The threshold distance associated with D2D communication (e.g., the D2D threshold range) may be equal to the second threshold distance. In other embodiments, the D2D threshold range may be greater than or less than the second threshold distance. Additionally, the maximum number of hops may be a preset value (e.g., one (meaning hopping is not permitted to occur via an intermediate device), two, three, or greater than three) or a value that a user (e.g., the group leader) say set using the application 156.

Referring to FIG. 7 and continuing with the example context provided therein, the electronic device 10 of the user 260B may be one hop (as indicated by line 334) from the electronic device of the user 260D, and the separated device (e.g., the electronic device 10 of the user 260A) may be one hop (indicated by line 336) from the electronic device 10 of the user 260B. Here, the first hop (e.g., the hop indicated by the line 334) may be within the D2D threshold distance. However, the electronic device 10 of the user 260A may be determined to not be within the D2D threshold distance (as indicated by the “X” on the line 336), for instance, when the separated electronic device determined to be a distance from the closest electronic device that is greater than the D2D threshold distance (or if the closest electronic device is located a distance from the electronic device 10 of the group leader that is greater than the D2D threshold distance).

Returning to FIG. 8 and the discussion of the process 300, upon determining that the separated device is within the D2D threshold range, in process block 314, the application 156 (e.g., as executed by one or more processors 12 of one or more of the electronic devices 10 or one or more processors 12 of the one or more servers 154) may determine to communicate waypoint data to the separated device using D2D communication. Accordingly, waypoint data (once determined) may potentially be routed between multiple electronic devices 10 of the users 260 before ultimately being received by the separated device.

Conversely, upon determining that the separated device is not within the D2D threshold range, the application 156 (e.g., as executed by one or more processors 12 of one or more of the electronic devices 10 or one or more processors 12 of the one or more servers 154) may determine to communicate waypoint data to the separated device via a satellite. In other words, the waypoint data (once determined) may be determined to be utilized to transmitted the waypoint data to the separated device. The waypoint data may originate from another of the electronic devices 10 or the one or more servers 154. Referring briefly to FIG. 7, in the illustrated context, the waypoint data may be transmitted from the electronic device 10 of the group leader (e.g., user 260D) to a satellite 338 (which may be included in the one or more base stations and/or satellites 152), and the satellite 338 may transmit the waypoint data to the electronic device 10 of the user 260A. In this manner, a mode of wireless communication may be determined to provide waypoint data to an electronic device 10 of a user who may be separated from other members of a group.

Returning to FIG. 5 and the discussion of the process 200, in process block 214, the application 156 (e.g., as executed by one or more processors 12 of one or more of the electronic devices 10 or one or more processors 12 of the one or more servers 154) may determine waypoint data, for instance, based on location data. The location data may pertain to the locations of the electronic devices 10, and the waypoint data may be indicative of, or include, directions and/or a travel route for a user to follow. For instance, the waypoint data, when displayed, may provide directions to enable a separated user to regroup with another member of the group, for example, at a position of the other member of the group or a “huddle point” such as one of the huddle points 340 (collectively referring to huddle point 340A and huddle point 340B). The huddle points 340 may be locations at which multiple users may meet, including users who have not been determined to be separated (e.g., by being a distance from the group leader that exceeds the first threshold distance discussed above with respect to process block 208). The waypoint data, when presented on the display 18, may appears as a series of dots or line segments that indicate directions for the user to follow. In some instances, the waypoint data may be indicative of instructions to stop moving or to reverse course. For example, if a user is determined to be too far ahead of other members of the group, the waypoint data may be indicative of directions for the user to stop (to wait for one or more other group members to become closer to the user) or for the user to turn around to move towards one or more other members of the group. The waypoint data may also be determined based on maps or other geographic data that may be stored in memory 14, storage 16, or external storage of any of the electronic devices 10 and/or the one or more servers 154.

In process block 216, the application 156 (e.g., as executed by one or more processors 12 of one or more of the electronic devices 10 or one or more processors 12 of the one or more servers 154) may cause the waypoint data (e.g., as determined at process block 214) to be transmitted to the separated device using the mode of communication determined at process block 212. For instance, in the context of FIG. 7, waypoint data for the electronic device 10 of the user 260C may be transmitted from the electronic device 10 of the user 260D using one or more UWB signals, whereas waypoint data for the electronic device 10 of the user 260A may be transmitted via the satellite 338 (which may receive the waypoint data from the electronic device 10 of the user 260D).

In process block 218, the application 156 (e.g., as executed by one or more processors 12 of one or more of the electronic devices 10 or one or more processors 12 of the one or more servers 154) may cause notification data to be sent to one or more electronic devices 10 of one or more other group members (e.g., members of the group who are not the separated user.) For example, the electronic device 10 of group leader may be sent (e.g., from the one or more servers 154 via the one or more base stations and/or satellites 152) and/or one or more electronic devices 10 of other member of the group (e.g., the electronic device 10 of the user determined to be closest to the separated user) may be sent notification data indicating that the separated user has become separated, the waypoint data, a location to which the separated user is to navigate by utilizing the waypoint data), or instructions (e.g., to stop to wait for the separated user, to move to or towards the separated user). Thus, waypoint data for users who are not separated may be provided in process block 218 to aid members of the group in regrouping. In this manner, waypoint data may be communicated to electronic devices 10 of separated users in a device-specific manner to enable the separated users to locate another member of the group or regroup with one or more members of the group.

While the discussion above discusses technique of the present application in the context of aiding separated users, the present disclosure is not limited to aiding users who are separated from another user by a threshold distance. In other words, in other embodiments, the decision to send waypoint data to an electronic device 10 may be based on something other than the distance of the user exceeding the threshold distance (e.g., as determined as decision block 210). For example, in other embodiments, a user may interact with a user interface of the application 156 to indicate that the user is separated or wants to regroup with one or more members of the group. In response to receiving such a user input, the application 156 (e.g., as executed by one or more processors 12 of one or more of the electronic devices 10 or one or more processors 12 of the one or more servers 154) may cause the operations discussed above with respect to process blocks 212, 214, 216, and/or 218 to be performed. In some embodiments, application 156 (e.g., as executed by one or more processors 12 of one or more of the electronic devices 10 or one or more processors 12 of the one or more servers 154) may perform the operations discussed above with respect to process blocks 212, 214, 216, and/or 218 to be performed (alternatively or additionally) in response to one or more particular weather conditions being present, visibility being relatively low (e.g., due to weather, pollution, time of day, relatively little sunlight (e.g., as the sun is setting or has already set) or ambient light), and/or remaining power (e.g., battery power or power remaining on the power source 29) on one or more electronic devices 10 being below a threshold amount of power (e.g., twenty percent, fifteen percent, ten percent, five percent, zero percent (e.g., device has run out of power) or any suitable threshold value amount of power). For example, in bad weather conditions or in low light situations (e.g., weather conditions worse than initial weather conditions), waypoint data may be provided to enable users to meet (e.g., at huddle points). In the context of generating and sending waypoint data based on the amount of power (e.g., of a power source 29) of an electronic device 10 being below a threshold, the device having the amount of remaining power beneath the threshold amount of power may be sent waypoint data. Additionally, in some cases, such as when the threshold amount of power is ten percent, five percent, or less than five percent (e.g., zero percent), waypoint data may be sent to one or more other electronic devices to enable other users to move towards the user with the device with power beneath the threshold amount of power. Additionally, if a user is using or wearing a peripheral electronic device (e.g., a smart watch), the waypoint data may be provided to the peripheral device.

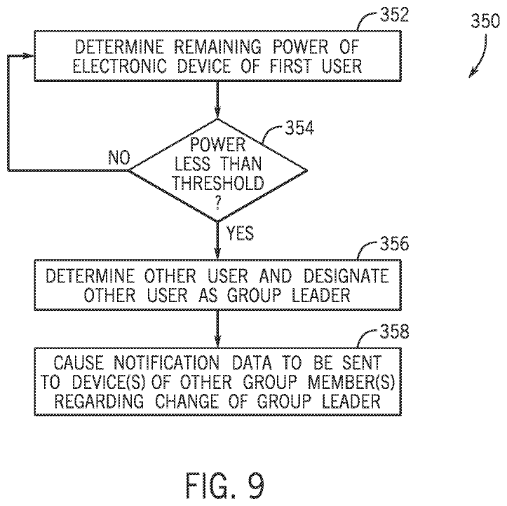

Furthermore, a new group leader may be designated when the electronic device 10 of the group leader has an amount of power that is beneath a threshold amount of power. Bearing this in mind, FIG. 9 is a flow diagram of a process 350 for designating a new group leader, according to embodiments of the present disclosure. Any suitable device (e.g., a controller) that may control components of the electronic device 10, such as the processor 12, may perform the process 350. In some embodiments, the process 350 may be implemented by executing instructions stored in a tangible, non-transitory, computer-readable medium, such as the memory 14 or storage 16, using the processor 12 (of one or more of the electronic devices 10, the one or more servers 154, or both). For example, the process 350 may be performed at least in part by one or more software components, such as an operating system of the electronic device 10, one or more software applications of the electronic device 10 or the one or more servers 154, such as the application 156. While the process 350 is described using steps in a specific sequence, it should be understood that the present disclosure contemplates that the described steps may be performed in different sequences than the sequence illustrated, and certain described steps may be skipped or not performed altogether.

In process block 352, the application 156 (e.g., as executed by one or more processors 12 of one or more of the electronic devices 10 or one or more processors 12 of the one or more servers 154) may determine an amount of remaining power (e.g., electrical power) of an electronic device 10 of a first user. For example, the application may determine an amount (e.g., a percentage or a value having a unit) of power remaining on the power source of the electronic device 10 of a first user, such as the group leader of a group in the application 156.

In decision block 354, the application 156 (e.g., as executed by one or more processors 12 of one or more of the electronic devices 10 or one or more processors 12 of the one or more servers 154) may determine whether the amount of remaining power is less than a threshold. For instance, the threshold may be a threshold amount of power (e.g., twenty percent, fifteen percent, ten percent, five percent, zero percent (e.g., device has run out of power) or any suitable threshold value amount of power). In one embodiment, the threshold amount of power may be a percentage. In other embodiments, the threshold amount of power may be an amount of time (e.g., one hour, forty-five minutes, thirty minutes, fifteen minutes, ten minutes, five minutes, zero minutes (corresponding to there being no remaining power) or any other suitable amount of time). In such embodiments, the application 156 may accordingly determine whether an estimated amount of remaining power (e.g., battery life) of the electronic device 10 is less than a threshold amount of time. Upon determining that the amount of remaining power is not less than the threshold, the process 350 may return to process block 352, and the application 156 may determine an amount of remaining power of the electronic device 10.

However, if in decision block 354 the application 156 determines that the amount of remaining power is less than the threshold, in process block 356, the application 156 (e.g., as executed by one or more processors 12 of one or more of the electronic devices 10 or one or more processors 12 of the one or more servers 154) may determine another user and designate the other user as the group leader of the group. In some embodiments, the other user may be determined based on proximity to the first user (e.g., an electronic device 10 of the other user being location closest to the electronic device 10 of the group leader). In other embodiments, the other user may alternatively or additionally be determined based on an amount of remaining power of the electronic device of the other user. For example, the user with the electronic device 10 having the most remaining power may be determined as the group leader. Additionally or alternatively, a user may be determined to be the group leader based on age. For example, in one embodiment, only adults may be determined to be group leaders (unless there are no remaining group members who are adults).

In process block 358, the application 156 (e.g., as executed by one or more processors 12 of one or more of the electronic devices 10 or one or more processors 12 of the one or more servers 154) may cause notification data to be transmitted to devices of other group members regarding the change of the group leader. For example, the application 156 may cause data to be transmitted to other electronic devices 10 of group members that, when displayed, is indicative of the group leader having changed from the first user to the other user (determined at process block 356).

In this manner, the process 350 may be performed to switch group leaders (e.g., due to an original group leader's electronic device having a relatively low amount of remaining power) and notify other group member of the change in group leaders.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112 (f). However, for any claims containing elements designated in any other manner, it is intended that such elements are not to be interpreted under 35 U.S.C. 112 (f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A non-transitory computer-readable medium comprising instructions that, when executed by processing circuitry, cause the processing circuitry to:
receive an indication of a location of a first electronic device of a plurality of electronic devices; and
cause one or more radio frequency (RF) signals to be transmitted to the first electronic device by a satellite based on the first electronic device not being communicatively coupled to a cellular network and the location of the first electronic device being separated from a second electronic device of the plurality of electronic devices by a distance exceeding a threshold distance.

2. (canceled)

3. The non-transitory computer-readable medium of claim 1, wherein the instructions, when executed, cause the processing circuitry to cause the one or more RF signals to be transmitted via the cellular network based on the first electronic device being communicatively coupled to the cellular network.

4. The non-transitory computer-readable medium of claim 3, wherein the instructions, when executed, cause the processing circuitry to cause the one or more RF signals to be transmitted using ultra-wideband communication based on the first electronic device not being communicatively coupled to the cellular network and the distance not exceeding the threshold distance.

5. The non-transitory computer-readable medium of claim 4, wherein the instructions, when executed, cause the processing circuitry to:
cause the one or more RF signals to be transmitted via device-to-device (D2D) communication based on the first electronic device being within a D2D threshold distance of one or more electronic devices of the plurality of electronic devices, the first electronic not being communicatively coupled to the cellular network, and the distance not exceeding the threshold distance; and
cause the one or more RF signals to be transmitted to the first electronic device by the satellite based on the first electronic device not being within the D2D threshold distance of the one or more electronic devices.

6. The non-transitory computer-readable medium of claim 1, wherein the instructions, when executed, cause the processing circuitry to:
receive a user input indicative of a value to use as a second threshold distance, wherein the second threshold distance is less than the threshold distance;
set the value as the second threshold distance; and
cause the one or more RF signals to be transmitted based on the distance exceeding the second threshold distance.

7. The non-transitory computer-readable medium of claim 1, wherein the instructions, when executed, cause the processing circuitry to receive a second indication from a third electronic device of the plurality of electronic devices indicative of
a second threshold distance that is less than the threshold distance, wherein the instructions, when executed, cause the processing circuitry to cause the one or more RF signals to be transmitted based on the distance exceeding the second threshold distance,
the second threshold distance being associated with the first electronic device or a first user of the first electronic device,
a third threshold distance different than the second threshold distance, and
the third threshold distance being associated with a fourth electronic device of the plurality of electronic devices or a second user of the fourth electronic device.

8. The non-transitory computer-readable medium of claim 1, wherein the instructions, when executed, cause the processing circuitry to:
receive a second indication of a user input indicative of a user of the first electronic device being lost or separated from one or more users associated with a set of the plurality of electronic devices that excludes the first electronic device; and
cause the one or more RF signals to be transmitted based on the second indication.

9. The non-transitory computer-readable medium of claim 1, wherein the instructions, when executed, cause the processing circuitry to
determine a second threshold distance based on weather conditions present at the location of the first electronic device, wherein the second threshold distance is less than the threshold distance, and
cause the one or more RF signals to be transmitted based on the distance exceeding the second threshold distance.

10. The non-transitory computer-readable medium of claim 1, wherein the instructions, when executed, cause the processing circuitry to:
determine that an amount of electrical power remaining in a power source of the first electronic device is less than a power threshold; and
cause the one or more RF signals to be transmitted based on the amount of electrical power remaining in the power source being less than the power threshold.

11. The non-transitory computer-readable medium of claim 1, wherein the one or more RF signals are indicative of waypoint data, the waypoint data being indicative of navigational directions for a user of the first electronic device.

12. An electronic device, comprising:
a transceiver; and
processing circuitry operatively coupled to the transceiver, wherein the processing circuitry is configured to
receive an indication of a location of a first electronic device of a plurality of electronic devices; and,
cause one or more radio frequency (RF) signals indicative of waypoint data to be transmitted to the first electronic device by a satellite based on the first electronic device not being communicatively coupled to a cellular network and the location of the first electronic device being separated from a second electronic device of the plurality of electronic devices by a distance exceeding a threshold distance, the waypoint data being indicative of navigational directions for a user of the first electronic device.

13. The electronic device of claim 12, wherein the processing circuitry is configured to cause the transceiver to transmit the one or more RF signals based on the first electronic device not being communicatively coupled to the cellular network and the distance not exceeding the threshold distance.

14. The electronic device of claim 12, wherein after the one or more RF signals are transmitted, the processing circuitry is configured to receive notification data indicative of the user being separated from one or more users of one or more electronic devices of the plurality of electronic devices other than the first electronic device.

15. The electronic device of claim 12, wherein the electronic device comprises the second electronic device.

16. A computer-implemented method, comprising:
receiving, via processing circuitry, an indication of a location of a first electronic device of a plurality of electronic devices; and
causing, via the processing circuitry, one or more radio frequency (RF) signals indicative of waypoint data to be transmitted to the first electronic device by a satellite based on the first electronic device not being communicatively coupled to a cellular network and the location of the first electronic device being separated from a second electronic device of the plurality of electronic devices by a distance exceeding a threshold distance, the waypoint data being indicative of navigational directions for a user of the first electronic device.

17. The computer-implemented method of claim 16, wherein the processing circuitry is included in the second electronic device.

18. The computer-implemented method of claim 16, wherein the processing circuitry is included in a server.

19. The computer-implemented method of claim 16, comprising determining second threshold distance that is less than the threshold distance based on an age of the user, weather at the location of the first electronic device, elevation of the location, topography of the location, a height of the user, a terrain of the location, or any combination thereof, wherein causing the one or more RF signals to be transmitted comprises causing the one or more RF signals to be to transmitted based on the distance exceeding the second threshold distance.

20. The computer-implemented method of claim 16, wherein:
the waypoint data is indicative of a meeting location at which the user can meet with one or more users of a portion of the plurality of electronic devices that excludes the first electronic device; and
the method comprises causing the processing circuitry to transmit additional waypoint data to the portion of the plurality of electronic devices, wherein the additional waypoint data is indicative of the meeting location.

21. The non-transitory computer-readable medium of claim 1, wherein the instructions, when executed, cause the processing circuitry to
determine a second threshold distance based at least in part on an age of a user of the first electronic device, and
cause the one or more RF signals to be transmitted based on the distance exceeding the second threshold distance.
